(19) United States
(12) Patent Application Publication
(10) Pub. No.: US 2009/0051970 A1
(43) Pub. Date: Feb. 26, 2009

(54) IMAGE DATA STORAGE METHODS, IMAGE DATA STORAGE CONTROL APPARATUSES, IMAGE DATA STORAGE PROGRAMS, METHODS AND APPARATUSES FOR FRAME DATA GENERATION AND PROGRAMS THEREFOR, METHODS AND APPARATUSES FOR DATA ACQUISITION, AND METHODS AND APPARATUSES FOR IMAGE DRAWING

(75) Inventor: Mitsuru Mushano, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku (JP)

(21) Appl. No.: 11/816,863

(22) PCT Filed: Feb. 22, 2006
(86) PCT No.: PCT/JP2006/303168

§ 371 Date: Oct. 15, 2007

(30) Foreign Application Priority Data
Feb. 22, 2005 (JP) 2005-045111

(51) Int. Cl. G06K 15/00; H04N 1/04

(52) U.S. Cl. 358/1.17; 358/1.16; 358/474

(57) ABSTRACT

An image data storage method is provided for obtaining image drawing spot data to be inputted to an image drawing spot forming unit that forms image drawing spots on an image drawing surface. The method comprises the step of storing the image data in storage means in such a manner that a direction along which addresses in the storage means are consecutive agrees with a direction of arrangement of the image data corresponding to a predetermined scanning direction of the image drawing spot forming unit relative to the image drawing surface.

### BACKGROUND OF THE INVENTION

1. Field of the Invention

The present invention relates to a method, an apparatus, and a program for storing image data used to form an image by moving in a predetermined scanning direction an image drawing spot forming unit such as a spatial light modulator relatively to an image drawing surface. The present invention also relates to a method and an apparatus for obtaining data inputted to the image drawing spot forming unit by use of the image data stored by the image data storage method and apparatus. In addition, the present invention relates to a method, an apparatus, and a program for generating frame data inputted to the image drawing spot forming unit by using the image data stored by the image data storage method and apparatus. Furthermore, the present invention relates to a method and an apparatus for drawing the image based on the frame data generated according to the method, the apparatus and the program for frame data generation.

2. Description of the Related Art

There have been known various kinds of image drawing apparatuses that form desired two-dimensional patterns represented by image data on image drawing surfaces.

Various kinds of exposure apparatuses have been proposed as such image drawing apparatuses. For example, an exposure apparatus has been proposed for carrying out exposure by modulating light beams by use of a spatial light modulator such as a digital micro-mirror device (hereinafter referred to as DMD) according to image data. A DMD comprises micro-mirrors laid out two-dimensionally on memory cells (an SRAM array) on a semi-conductor substrate of silicon or the like. By controlling electrostatic forces caused by charges stored in the memory cells, the micro-mirrors are tilted to change reflection angles thereof. Image drawing spots can then be generated at desired positions according to the changes in the reflection angles, to form an image.

As an exposure apparatus using a DMD, an exposure apparatus has been proposed in Japanese Unexamined Patent Publication No. 2003-50469. In this apparatus, a DMD is moved in a predetermined scanning direction relatively to an exposure surface while frame data comprising image drawing spot data corresponding to micro-mirrors are inputted to memory cells of the DMD. By temporally serially forming image drawing spots according to the micro-mirrors in the DMD, a desired image is formed on an exposure surface. An exposure apparatus for carrying out exposure by setting a DMD to form a predetermined angle with a scanning direction has also been proposed, in order to improve resolution of an image formed on an exposure surface.

When such an exposure apparatus carries out exposure, frame data need to be inputted to a DMD according to movement of the DMD in a predetermined scanning direction. Therefore, a plurality of frame data sets corresponding to positions of the DMD relative to an exposure surface need to be generated before the exposure.

Hereinafter will be described a conventional method of generating frame data sets for the case where a figure “2” is drawn on an exposure surface as shown in FIGS. 11A to 11O. Symbols [symbol] to [symbol] shown in FIGS. 11A to 11O represent micro-mirrors in a DMD, and Frames 1 to 15 at the bottom of FIGS. 11A to 11O represent frame data sets to be inputted to the DMD at respective positions shown therein.

In the conventional method, image drawing spot data (image data) corresponding to respective image drawing spots shown in FIGS. 11A to 11O are temporarily stored in a memory such as a DRAM (Dynamic Random Access Memory), and the frame data sets are generated by sequentially reading from the memory the image drawing spot data corresponding to the micro-mirrors of the DMD shown by [symbol] to [symbol] in FIGS. 11A to 11O at the respective positions. The image drawing spot data corresponding to the image drawing spots represented by open squares and hatched squares in FIGS. 11A to 11O are 0 which means “OFF” while the image drawing spot data corresponding to the image drawing spots represented by black squares are 1 which means “ON”. The range represented by the hatched squares is an actual range in which the image is drawn on an image drawing surface, and the image drawing spot data corresponding thereto are 0 as for the open squares.

However, if the frame data sets are generated by sequential reading of the image drawing spot data shown by [symbol] to [symbol] corresponding to the micro-mirrors, acquisition of all the frame data sets is time-consuming in the case where consecutive addresses are assigned in a direction perpendicular to the scanning direction in FIGS. 11A to 11O and reading from the memory is controlled so as to sequentially read the image drawing spot data in the direction of consecutive addresses. This is because addresses in a memory space storing the image drawing spot data corresponding to the micro-mirrors are distributed discretely for memory control means, and reading the image drawing spot data while accessing the respective addresses assigned in the above manner is time-consuming for memory control.

The present invention has been conceived based on consideration of the above circumstances, and an object of the present invention is to provide an image data storage method, an image data storage control apparatus, an image data storage program, a data acquisition method, a data acquisition apparatus, a frame data generation method, a frame data generation apparatus, and a frame data generation program that enable fast generation of frame data and to provide a method and an apparatus that use the image data storage method and the like described above.

### SUMMARY OF THE INVENTION

A first image data storage method of the present invention is a method of storing image data for obtaining image drawing spot data to be inputted to an image drawing spot forming unit that forms image drawing spots on an image drawing surface, and the method comprises the step of:

storing the image data in storage means in such a manner that a direction along which addresses in the storage means are consecutive agrees with a direction of arrangement of the image data corresponding to a predetermined scanning direction of the image drawing spot forming unit relative to the image drawing surface.

In the first image data storage method of the present invention, the storage means may be configured or set to enable collective reading of a plurality of bits along the direction of consecutive addresses at the time of reading of the image data.

In addition, the direction of consecutive addresses may be a direction configured or set as a path in which a plurality of bits are sequentially read at the time of reading of the image data from the storage means.

A second image data storage method of the present invention is a method of storing image data for obtaining image drawing spot data to be inputted to an image drawing spot forming unit that forms image drawing spots on an image drawing surface, and the method comprises the steps of:

carrying out compression processing on the image data along a direction of arrangement of the image data corresponding to a scanning direction of the image drawing spot forming unit relative to the image drawing surface; and

storing compressed image data having been generated by the compression processing in storage means in such a manner that a direction along which the compressed image data are arranged agrees with a direction of consecutive addresses in the storage means.

The image data may be binary data while the compression processing may be runlength compression.

The image drawing spot forming unit may comprise a plurality of orderly arranged modulators that modulate an incident light.

The image drawing spot forming unit may be a GLV (Grating Light Valve).

The image drawing spot forming unit may be a digital micro-mirror device.

The image drawing spot forming unit may be a plurality of light emitting elements arranged orderly.

A first data acquisition method of the present invention comprises the step of obtaining the image drawing spot data or interim data including more than one of the image drawing spot data by reading in the direction of consecutive addresses the image data stored in the storage means according to the first image data storage method of the present invention.

In the first data acquisition method of the present invention, the image drawing spot data or the interim data can be read for respective elements of the image drawing spot forming unit.

A second data acquisition method of the present invention comprises the steps of:

reading the compressed image data stored in the storage means according to the second image data storage method of the present invention, in the direction of consecutive addresses; and

obtaining the image drawing spot data by decompressing the compressed image data having been read.

A first frame data generation method of the present invention is a method of generating frame data sets by reading the image drawing spot data from the image data stored in the storage means according to the first image data storage method of the present invention, and the first frame data generation method comprises the steps of:

reading the image drawing spot data from the image data stored in the storage means, in the direction of consecutive addresses; and

generating the frame data sets by obtaining more than one of the image drawing spot data belonging to each of the frame data sets from more than one of the image drawing spot data having been read.

In the first frame data generation method of the present invention, frame data storage means from which the image drawing spot data stored therein can be read sequentially in a direction of consecutive addresses may be used. In this case, the image drawing spot data are stored in the frame data storage means in such a manner that the direction of consecutive addresses agrees with a direction of arrangement of the image drawing spot data belonging to the respective frame data sets, and the frame data sets can be generated by sequentially reading the image drawing spot data belonging to the respective frame data sets.

A second frame data generation method of the present invention comprises the steps of:

sequentially reading the compressed image data stored in the storage means according to the second image data storage method of the present invention, in the direction of consecutive addresses;

generating more than one of the image drawing spot data by carrying out decompression on the compressed image data having been read; and

thereafter generating frame data sets by obtaining more than one of the image drawing spot data belonging to each of the frame data sets from said more than one of the image drawing spot data having been generated.

In the second frame data generation method of the present invention, frame data storage means from which the image drawing spot data stored therein can be read sequentially in a direction of consecutive addresses may be used. In this case, the image drawing spot data are stored in the frame data storage means in such a manner that the direction of consecutive addresses agrees with a direction of arrangement of the image drawing spot data belonging to the respective frame data sets after the decompression, and the frame data sets can be generated by sequentially reading the image drawing spot data belonging to the respective frame data sets.

A first image drawing method of the present invention comprises the steps of:

obtaining the image drawing spot data according to the first data acquisition method of the present invention; and

forming an image on the image drawing surface by moving the image drawing spot forming unit relatively to the image drawing surface in the predetermined scanning direction while generating the image drawing spots through sequential input of the image drawing spot data to the image drawing spot forming unit according to movement of the image drawing spot forming unit in the scanning direction.

A second image drawing method of the present invention comprises the steps of:

obtaining the image drawing spot data according to the second data acquisition method of the present invention; and

forming an image on the image drawing surface by moving the image drawing spot forming unit relatively to the image drawing surface in the predetermined scanning direction while generating the image drawing spots through sequential input of the image drawing spot data to the image drawing spot forming unit according to movement of the image drawing spot forming unit in the scanning direction.

A third image drawing method of the present invention comprises the steps of:

obtaining the frame data sets according to the first frame data generation method of the present invention; and

forming an image on the image drawing surface by moving the image drawing spot forming unit relatively to the image drawing surface in the predetermined scanning direction while temporally serially generating the image drawing spots through sequential input of the frame data sets to the image drawing spot forming unit according to movement of the image drawing spot forming unit in the scanning direction.

A fourth image drawing method of the present invention comprises the steps of:

obtaining the frame data sets according to the second frame data generation method of the present invention; and

forming an image on the image drawing surface by moving the image drawing spot forming unit relatively to the image drawing surface in the predetermined scanning direction while temporally serially generating the image drawing spots through sequential input of the frame data sets to the image drawing spot forming unit according to movement of the image drawing spot forming unit in the scanning direction.

A first image data storage control apparatus of the present is an image data storage control apparatus that stores in storage means image data for obtaining image drawing spot data to be inputted to an image drawing spot forming unit that forms image drawing spots on an image drawing surface, and the apparatus comprises:

storage control means for storing the image data in the storage means in such a manner that a direction along which addresses in the storage means are consecutive agrees with a direction of arrangement of the image data corresponding to a predetermined scanning direction of the image drawing spot forming unit relative to the image drawing surface.

In the first image data storage control apparatus of the present invention, the storage means may be configured or set to enable collective reading of a plurality of bits along the direction of consecutive addresses at the time of reading of the image data.

In addition, the direction of consecutive addresses may be a direction configured or set as a path in which a plurality of bits are sequentially read at the time of reading of the image data from the storage means.

A second image data storage control apparatus of the present invention is an apparatus for storing in storage means image data for obtaining image drawing spot data to be inputted to an image drawing spot forming unit that forms image drawing spots on an image drawing surface, and the apparatus comprises:

compression processing means for carrying out compression processing on the image data along a direction of arrangement of the image data corresponding to a scanning direction of the image drawing spot forming unit relative to the image drawing surface; and

storage control means for storing compressed image data having been generated through the compression processing by the compression processing means in the storage means in such a manner that a direction along which the compressed image data are arranged agrees with a direction of consecutive addresses in the storage means.

The image data may be binary data while the compression processing may be runlength compression.

The image drawing spot forming unit may comprise a plurality of orderly arranged modulators that modulate an incident light.

The image drawing spot forming unit may be a GLV (Grating Light Valve).

The image drawing spot forming unit may be a digital micro-mirror device.

The image drawing spot forming unit may be a plurality of light emitting elements arranged orderly.

A first data acquisition apparatus of the present invention comprises:

the first image data storage control apparatus of the present invention; and

a data acquisition unit for obtaining the image drawing spot data or interim data including more than one of the image drawing spot data by reading in the direction of consecutive addresses the image data stored in the storage means by the first image data storage control apparatus of the present invention.

In the first data acquisition apparatus of the present invention, the data acquisition unit can read the image drawing spot data or the interim data for respective elements of the image drawing spot forming unit.

A second data acquisition apparatus of the present invention comprises:

the second image data storage control apparatus of the present invention; and

a data acquisition unit for reading in the direction of consecutive addresses the compressed image data stored in the storage means by the second image data storage control apparatus of the present invention and for obtaining the image drawing spot data by decompressing the compressed image data.

A first frame data generation apparatus of the present invention is a frame data generation apparatus comprising:

the first image data storage control apparatus of the present invention; and

frame data generating means for generating frame data sets by reading the image drawing spot data from the image data stored in the storage means by the first image data storage control apparatus of the present invention, wherein

the frame data generating means reads the image drawing spot data from the image data stored in the storage means, in the direction of consecutive addresses, and

generates the frame data sets by obtaining more than one of the image drawing spot data belonging to each of the frame data sets from more than one of the image drawing spot data having been read.

The first frame data generation apparatus of the present invention may further comprise frame data storage means from which the image drawing spot data stored therein can be read sequentially in a direction of consecutive addresses. In this case, the frame data generating means stores the image drawing spot data in the frame data storage means in such a manner that the direction of consecutive addresses agrees with a direction of arrangement of the image drawing spot data belonging to the respective frame data sets, and thereafter generates the frame data sets by sequentially reading the image drawing spot data belonging to the respective frame data sets.

A second frame data generation apparatus of the present invention comprises:

the second image data storage control apparatus of the present invention; and

frame data generating means for sequentially reading in the direction of consecutive addresses the compressed image data stored in the storage means by the second image data storage control apparatus of the present invention, for generating more than one of the image drawing spot data by carrying out decompression on the compressed image data having been read, and for generating frame data sets by obtaining more than one of the image drawing spot data belonging to each of the frame data sets from said more than one of the image drawing spot data having been generated.

The second frame data generation apparatus of the present invention may further comprise frame data storage means from which the image drawing spot data stored therein can be read sequentially in a direction of consecutive addresses. In this case, the frame data generating means stores the image drawing spot data in the frame data storage means in such a manner that the direction of consecutive addresses agrees with a direction of arrangement of the image drawing spot data belonging to the respective frame data sets after the decompression, and thereafter generates the frame data sets by sequentially reading the image drawing spot data belonging to the respective frame data sets.

A first image drawing apparatus of the present invention comprises:

the first data acquisition apparatus of the present invention;

the image drawing spot forming unit that forms the image drawing spots on the image drawing surface based on the image drawing spot data inputted thereto;

moving means for moving the image drawing spot forming unit in the predetermined scanning direction relatively to the image drawing surface; and

image forming control means for sequentially inputting to the image drawing spot forming unit the image drawing spot data obtained by the first data acquisition apparatus of the present invention according to the movement in the scanning direction by the moving means and for forming an image on the image drawing surface by causing the image drawing spot forming unit to sequentially form the image drawing spots.

A second image drawing apparatus of the present invention comprises:

the second data acquisition apparatus of the present invention;

the image drawing spot forming unit that forms the image drawing spots on the image drawing surface based on the image drawing spot data inputted thereto;

moving means for moving the image drawing spot forming unit in the predetermined scanning direction relatively to the image drawing surface; and

image forming control means for sequentially inputting to the image drawing spot forming unit the image drawing spot data obtained by the second data acquisition apparatus of the present invention according to the movement in the scanning direction by the moving means and for forming an image on the image drawing surface by causing the image drawing spot forming unit to sequentially form the image drawing spots.

A third image drawing apparatus of the present invention comprises:

the first frame data generation apparatus of the present invention;

the image drawing spot forming unit that forms the image drawing spots on the image drawing surface based on the frame data sets inputted thereto;

moving means for moving the image drawing spot forming unit in the predetermined scanning direction relatively to the image drawing surface; and

image forming control means for sequentially inputting to the image drawing spot forming unit the frame data sets generated by the first frame data generation apparatus of the present invention according to the movement in the scanning direction by the moving means and for forming an image on the image drawing surface by causing the image drawing spot forming unit to temporally serially form the image drawing spots.

A fourth image drawing apparatus of the present invention comprises:

the second frame data generation apparatus of the present invention;

the image drawing spot forming unit that forms the image drawing spots on the image drawing surface based on the frame data sets inputted thereto;

moving means for moving the image drawing spot forming unit in the predetermined scanning direction relatively to the image drawing surface; and

image forming control means for sequentially inputting to the image drawing spot forming unit the frame data sets generated by the second frame data generation apparatus of the present invention according to the movement in the scanning direction by the moving means and for forming an image on the image drawing surface by causing the image drawing spot forming unit to temporally serially form the image drawing spots.

A first recording medium of the present invention stores a first image data storage program causing a computer to execute the procedure of storing in storage means image data for obtaining image drawing spot data to be inputted to an image drawing spot forming unit that forms image drawing spots on an image drawing surface, and the program comprises the procedure of:

storing the image data in the storage means in such a manner that a direction along which addresses in the storage means are consecutive agrees with a direction of arrangement of the image data corresponding to a predetermined scanning direction of the image drawing spot forming unit relative to the image drawing surface.

A second recording medium of the present invention stores a second image data storage program causing a computer to execute the procedures for storing in storage means image data for obtaining image drawing spot data to be inputted to an image drawing spot forming unit that forms image drawing spots on an image drawing surface, and the program comprises the procedures of:

carrying out compression processing on the image data along a direction of arrangement of the image data corresponding to a scanning direction of the image drawing spot forming unit relative to the image drawing surface; and

storing compressed image data having been generated by the compression processing in the storage means in such a manner that a direction along which the compressed image data are arranged agrees with a direction of consecutive addresses in the storage means.

The image data may be binary data while the compression processing may be runlength compression.

A third recording medium of the present invention stores a frame data generation program causing a computer to execute the procedures for generating frame data sets by reading the image drawing spot data from the storage means according to the first image data storage program of the present invention, and the frame data generation program comprises the procedures of:

reading the image drawing spot data from the image data stored in the storage means, in the direction of consecutive addresses; and

generating the frame data sets by obtaining more than one of the image drawing spot data belonging to each of the frame data sets from more than one of the image drawing spot data having been read.

A fourth recording medium of the present invention may store the frame data generation program further causing the computer to execute the procedure of:

storing the image drawing spot data in frame data storage means from which the image drawing spot data stored therein can be read sequentially in a direction of consecutive addresses, in such a manner that the direction of consecutive addresses agrees with a direction of arrangement of the image drawing spot data belonging to the respective frame data sets. In this case, the step of generating is the step of generating the frame data sets by sequentially reading the image drawing spot data belonging to the respective frame data sets.

A third image data storage method of the present invention comprises the steps of:

preparing image data for obtaining image drawing spot data to be inputted to respective image drawing elements at the time an image is formed through generation of serial image drawing spots in a relative scanning direction on an image drawing surface by the image drawing elements; and

storing the image data in storage means in such a manner that a direction along which addresses in the storage means are consecutive agrees with a direction of arrangement of the image data corresponding to the direction of serial generation of the image drawing spots.

A fourth image data storage method of the present invention comprises the steps of:

preparing image data for obtaining image drawing spot data to be inputted to respective image drawing elements at the time an image is formed through generation of serial image drawing spots in a relative scanning direction on an image drawing surface by the image drawing elements;

compressing the image data in a direction of data arrangement corresponding to the direction of serial generation of the image drawing spots; and

storing the compressed image data in storage means.

In the fourth image data storage method of the present invention, the compressed image data may be stored in the storage means in such a manner that a direction along which addresses in the storage means are consecutive agrees with a direction of compression.

A fifth image drawing method of the present invention comprises the steps of:

reading image drawing spot data for respective image drawing elements from image data stored in storage means; and

forming an image through generation of serial image drawing spots in a scanning direction on an image drawing surface by the respective image drawing elements, based on the image drawing spot data having been read.

A sixth image drawing method of the present invention comprises the steps of:

reading image drawing spot data in order of addresses corresponding to respective image drawing elements from image data stored in storage means; and

forming an image through generation of serial image drawing spots in a scanning direction on an image drawing surface by the image drawing elements, based on the image drawing spot data having been read.

In the fifth and sixth image drawing methods of the present invention, a plurality of bits may be read collectively at the time of reading of the image drawing spot data.

In addition, the image data may be stored in advance in the storage means in such a manner that a direction along which addresses in the storage means are consecutive agrees with a direction of arrangement of the image data corresponding to the direction of serial generation of the image drawing spots.

A third image data storage control apparatus of the present invention comprises:

image data acquisition means for obtaining image data for acquisition of image drawing spot data to be inputted to respective image drawing elements at the time an image is formed through generation of serial image drawing spots in a relative scanning direction on an image drawing surface by the image drawing elements; and

storage control means for storing the image data in storage means in such a manner that a direction along which addresses in the storage means are consecutive agrees with a direction of arrangement of the image data corresponding to the direction of serial generation of the image drawing spots.

A fourth image data storage control apparatus of the present invention comprises:

image data acquisition means for obtaining image data to be inputted to respective image drawing elements at the time an image is formed through generation of serial image drawing spots in a relative scanning direction on an image drawing surface by the image drawing elements;

compression processing means for compressing the image data in a direction of data arrangement corresponding to the direction of serial generation of the image drawing spots; and

storage control means for storing the compressed image data in storage means.

In the fourth image data storage control apparatus of the present invention, the storage control means may store the compressed image data in the storage means in such a manner that a direction along which addresses in the storage means are consecutive agrees with a direction of compression.

A fifth image drawing apparatus of the present invention comprises:

image drawing spot data acquisition means for obtaining image drawing spot data for respective image drawing elements by reading the image drawing spot data from image data stored in storage means; and

image drawing means for forming an image through generation of serial image drawing spots in a scanning direction on an image drawing surface by the respective image drawing elements, based on the image drawing spot data having been obtained by the image drawing spot data acquisition means.

A sixth image drawing apparatus of the present invention comprises:

image drawing spot data acquisition means for obtaining image drawing spot data by reading the image drawing spot data in order of addresses corresponding to image drawing elements from image data stored in storage means; and

image drawing means for forming an image through generation of serial image drawing spots in a scanning direction on an image drawing surface by the image drawing elements, based on the image drawing spot data having been obtained by the image drawing spot data acquisition means.

In the fifth and sixth image drawing apparatuses of the present invention, the image drawing spot data acquisition means may read a plurality of bits collectively at the time of reading of the image drawing spot data.

In addition, the fifth and sixth image drawing apparatuses may further comprise storage control means for storing the image data in advance in the storage means in such a manner that a direction along which addresses in the storage means are consecutive agrees with a direction of arrangement of the image data corresponding to the direction of serial generation of the image drawing spots.

The storage means may be the same as or separate from the frame data storage means.

According to the image data storage methods, the image data storage control apparatuses, the image data storage programs, the data acquisition methods, the data acquisition apparatuses, the frame data generation methods, the frame data generation apparatuses, the frame data generation programs, the image drawing methods, and the image drawing apparatuses related to embodiments of the present invention, the image drawing spot data can be read fast and/or efficiently from the storage means.

In addition, according to the image drawing methods and the image drawing apparatuses using the image data storage methods and the like of the present invention, the frame data sets can be generated fast. Therefore, image drawing time from input of the image data to completion of image drawing can be shortened.

Furthermore, in the image data storage methods and the like of the present invention, in the case where the compression processing is carried out in the direction of data arrangement on more than one of the image drawing spot data corresponding to the image drawing spots aligned in the scanning direction and the compressed image data are stored in the storage means in such a manner that the direction of storage of the compressed image drawing spot data agrees with the direction of consecutive addresses, an amount of data read from the storage means becomes smaller by an amount of compression. Therefore, reading time can be shortened due to the compressed data, and generation of the frame data sets can thus become faster.

### BRIEF DESCRIPTION OF THE DRAWINGS

FIG. 1 is a perspective view representing appearance of an exposure apparatus using an embodiment of an image drawing apparatus of the present invention;

FIG. 2 is a perspective view of the configuration of a scanner of the exposure apparatus shown in FIG. 1;

FIG. 3A is a top view representing exposed areas formed on a photosensitive material;

FIG. 3B shows arrangement of exposure areas of exposure heads;

FIG. 4 is a partial enlargement showing the configuration of a DMD in the exposure apparatus shown in FIG. 1;

FIG. 5A is a perspective view showing operation of the DMD;

FIG. 5B is a perspective view showing operation of the DMD;

FIG. 6 is a block diagram showing a control system in the exposure apparatus of FIG. 1;

FIG. 7 shows a relationship between an address space in image data storage means for storage control means and image data stored in the image data storage means;

FIG. 8A shows a frame data generation method in the exposure apparatus in FIG. 1;

FIG. 8B shows the frame data generation method in the exposure apparatus in FIG. 1;

FIG. 8C shows the frame data generation method in the exposure apparatus in FIG. 1;

FIG. 8D shows the frame data generation method in the exposure apparatus in FIG. 1;

FIG. 8E shows the frame data generation method in the exposure apparatus in FIG. 1;

FIG. 8F shows the frame data generation method in the exposure apparatus in FIG. 1;

FIG. 8G shows the frame data generation method in the exposure apparatus in FIG. 1;

FIG. 8H shows the frame data generation method in the exposure apparatus in FIG. 1;

FIG. 9 shows a relationship between an address space in frame data storage means for frame data generation means and frame data sets stored in the frame data storage means;

FIG. 10 is a block diagram of a control system in an exposure apparatus using another embodiment of an image drawing apparatus of the present invention;

FIG. 11A shows a conventional frame data generation method;

FIG. 11B shows the conventional frame data generation method;

FIG. 11C shows the conventional frame data generation method;

FIG. 11D shows the conventional frame data generation method;

FIG. 11E shows the conventional frame data generation method;

FIG. 11F shows the conventional frame data generation method;

FIG. 11G shows the conventional frame data generation method;

FIG. 11H shows the conventional frame data generation method;

FIG. 11I shows the conventional frame data generation method;

FIG. 11J shows the conventional frame data generation method;

FIG. 11K shows the conventional frame data generation method;

FIG. 11L shows the conventional frame data generation method;

FIG. 11M shows the conventional frame data generation method;

FIG. 11N shows the conventional frame data generation method; and

FIG. 11O shows the conventional frame data generation method.

### DESCRIPTION OF THE PREFERRED EMBODIMENTS

Hereinafter an exposure apparatus using an embodiment of an image data storage method, an image data storage control apparatus, an image data storage program, a data acquisition method, a data acquisition apparatus, a frame data generation method, a frame data generation apparatus, a frame data generation program, an image drawing method, and an image drawing apparatus of the present invention will be described in detail with reference to the accompanying drawings.

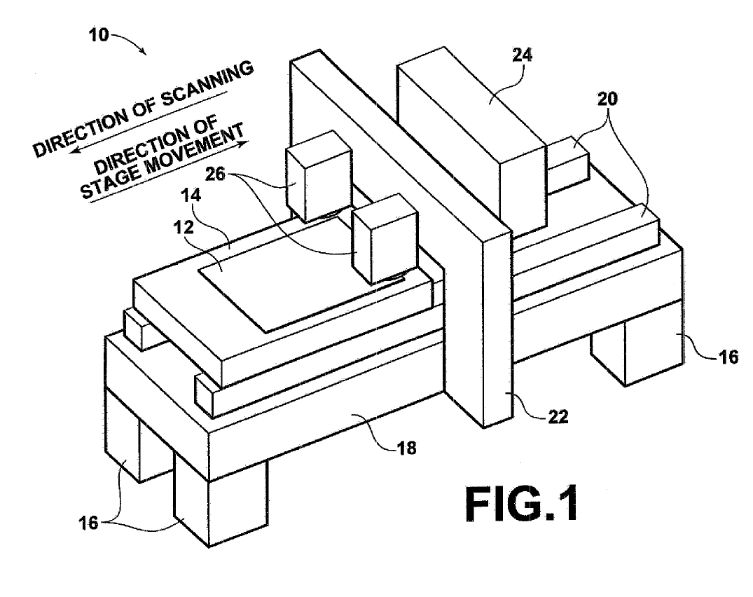

The exposure apparatus is an exposure apparatus using a DMD as an image drawing spot forming unit of the present invention. A method of generating image drawing spot data such as frame data inputted to the DMD is characteristic to the present invention. Firstly, the configuration of the exposure apparatus in this embodiment will be described. FIG. 1 is a perspective view showing the configuration of the exposure apparatus in this embodiment.

As shown in FIG. 1, an exposure apparatus 10 in this embodiment comprises a planer movement stage 14 for holding a photosensitive material 12 (or a substrate coated or pasted with a photosensitive material 12) by suction. On the upper surface of a thick plate-like mount 18 supported by four legs 16 are placed two guide rails 20 extending along a direction of movement of the stage 14. The stage 14 is placed in such a manner that a direction of longer sides thereof is parallel to the direction of movement thereof. The stage 14 is supported by the guide rails 20 so that the stage 14 can move back and forth along the rails.

A U-shaped gate 22 is situated at the center of the mount 18 so as to straddle the path of the stage 14. Both ends of the U-shaped gate 22 are fixed to side faces of the mount 18. A scanner 24 is situated beside the U-shaped gate 22 while a plurality (such as 2) of sensors 26 are placed opposite to the scanner 24 across the gate 22. The sensors 26 detect front and rear ends of the photosensitive material 12. The scanner 24 and the sensors 26 are attached to the gate 22 at fixed positions around the start of forward movement of the stage 14. The scanner 24 and the sensors 26 are connected to a control unit for controlling the scanner and the sensors as will be described later. The position of the photosensitive material 12 may be measured by reading a mark or a pattern thereon with a sensor such as a CCD.

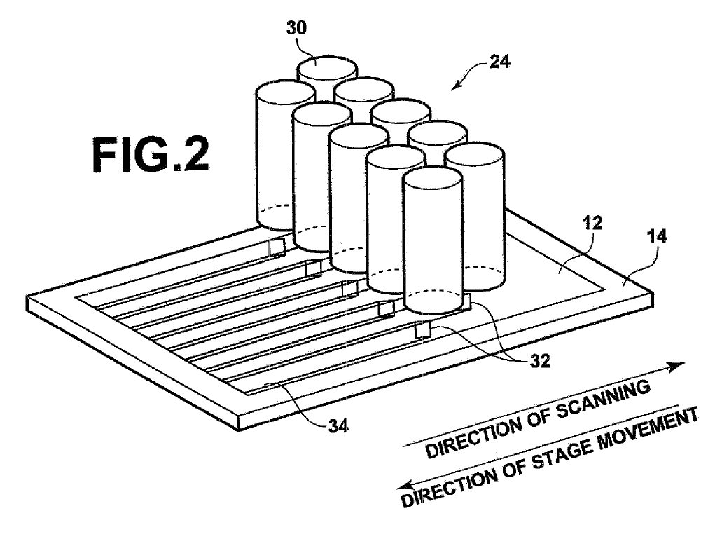

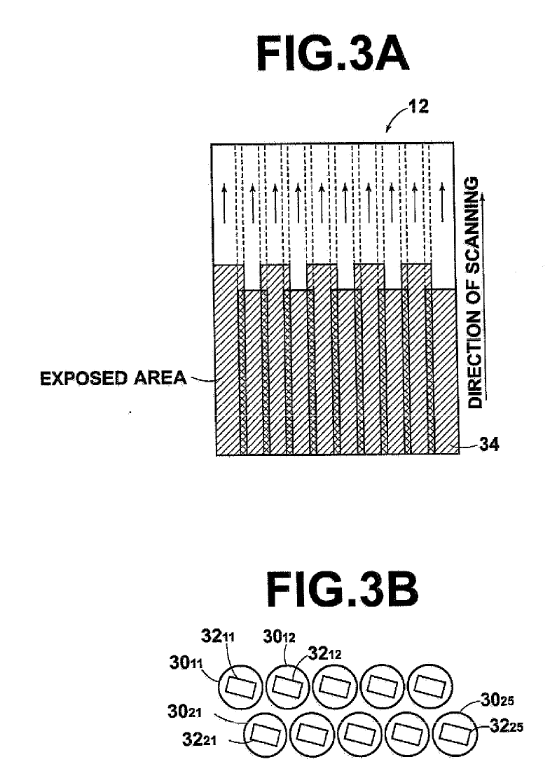

The scanner 24 comprises 10 exposure heads 30 laid out in a shape close to a matrix of 2 rows and 5 columns, as shown in FIG. 2 and FIG. 3B. Hereinafter, one of the exposure heads 30 situated in an m^{th} row in an n^{th} column is expressed as an exposure head 30ₘₙ. The number of the exposure heads 30 can be changed according to a size of the photosensitive material 12 to be exposed.

Each of the exposure heads 30 comprises a DMD 36 as a spatial light modulator. The DMD 36 has micro-mirrors as image drawing elements arranged in a two-dimensional orthogonal grid. The DMD 36 is installed in the corresponding exposure head 30 in such a manner that a direction of micro-mirror rows in the DMD 36 forms a predetermined angle with the direction of scanning. Therefore, an exposure area 32 of each of the exposure heads 30 is shaped into a rectangle that is diagonal to the direction of scanning, as shown in FIG. 2 and FIG. 3B. Images from the micro-mirrors are formed two-dimensionally in these areas. Hereinafter, an exposure area formed by the exposure head in the m^{th} row in the n^{th} column is denoted by the exposure area 32ₘₙ. In the exposure apparatus in this embodiment, the DMD 36 is set to be diagonal by the predetermined angle. However, the DMD 36 may be installed parallel to the scanning direction. In addition, the micro-mirrors in the DMD (or the images from the mirrors) may be installed to form a parallelogram or a zigzag pattern. Alternatively, the stage 14 may be moved along a direction that is diagonal to the arrangement of the micro-mirrors (or the images from the mirrors).

A fiber array light source (not shown) and a light condensing lens system (not shown) are placed on the light incident side of the DMDs 36. The fiber-array light source has light emission points of optical fibers aligned along a direction corresponding to a direction of a longer side of the exposure areas 32. The light condensing lens system causes laser beams emitted from the fiber array light source to become parallel and to focus on the corresponding DMDs 36 with uniform distribution of light.

An image forming lens system (not shown) is also situated on the path of light reflected from the DMDs 36, for causing the laser beams reflected by the DMDs 36 to form the images on the photosensitive material 12.

As shown in FIG. 3A, following the movement of the stage 14, a strip of exposed area 34 corresponding to each of the exposure heads 30 is formed on the photosensitive material 12. The linearly aligned exposure heads 30 are arranged at a predetermined interval so that each of the exposed areas 34 partially overlaps with the neighboring exposed areas 34. Therefore, an area between the exposure areas 32₁₁ and 32₁₂ that cannot be exposed by the exposure heads in the first row can be exposed by the neighboring exposure area 32₂₁ in the second row.

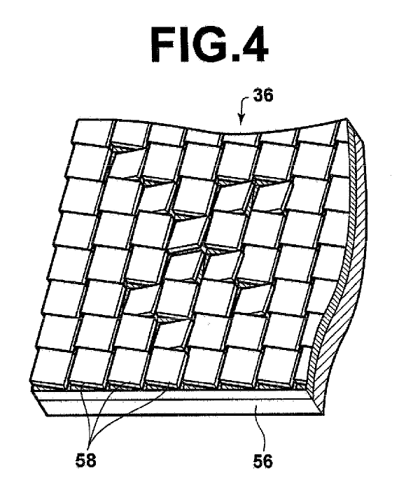

As shown in FIG. 4, each of the DMDs 36 has micro-mirrors 58 supported by posts on an SRAM array (memory cells). The DMDs 36 are mirror devices each having the micro-mirrors 58 comprising pixels (such as 768×1024 pixels at 13.68 μm intervals) arranged in a two-dimensional orthogonal grid. Under the micro-mirrors 58 is situated the SRAM array 56 comprising CMOS'es having silicon gates produced in an ordinary semi-conductor memory production line with the posts including hinges and yokes.

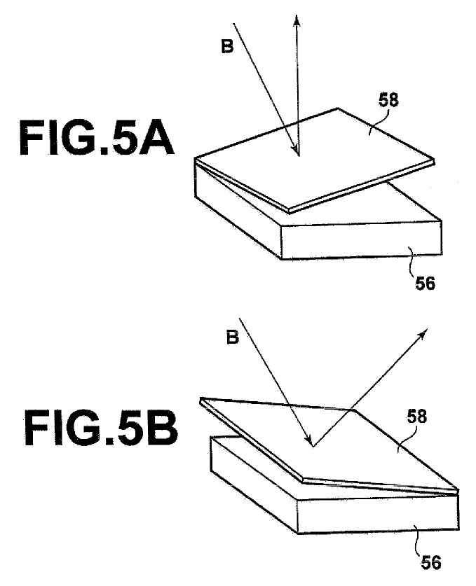

When digital signals as control signals are written in the SRAM array 56 in each of the DMDs 36, a control voltage corresponding to each of the digital signals is applied to an electrode (not shown) of each of the micro-mirrors 58, and each of the micro-mirrors 58 supported by the post tilts, in an angle of −α or +α degrees (such as −10 or +10 degrees) around a diagonal line thereof in response to an electrostatic force generated by the control voltage. FIG. 5A shows an ON state wherein one of the micro-mirrors 58 is tilted by α degrees while FIG. 5B shows an OFF state wherein the micro-mirror 58 is tilted by −α degrees. An incident light B to one of the micro-mirrors 58 in the ON state is reflected to the photosensitive material 12. On the other hand, the light B is reflected toward a light absorbing material other then the photosensitive material 12 in the case where the micro-mirror 58 is in the OFF state.

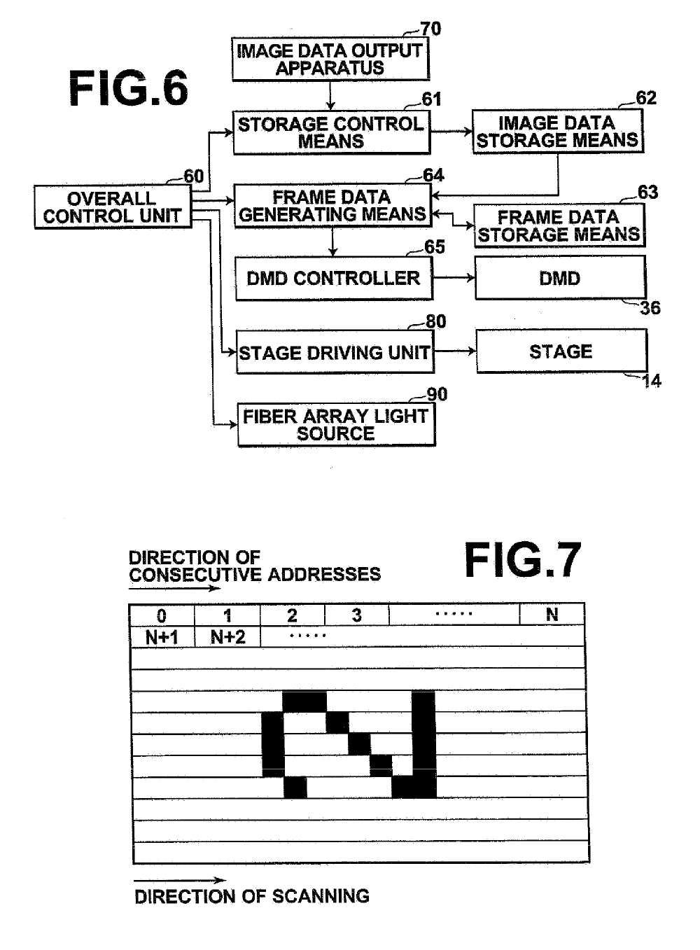

As shown in FIG. 6, the exposure apparatus 10 has an overall control unit 60 comprising a CPU for controlling the entire exposure apparatus 10. The control unit 60 receives image data outputted from an image data output apparatus 70, generates frame data sets based on the image data, and outputs the frame data sets to a DMD controller 65, for controlling exposure by the DMD 36 of each of the exposure heads 30. The control unit 60 also controls a fiber array light source 90 and a stage driving unit 80 that moves the stage 14.

As shown in FIG. 6, the exposure apparatus 10 also comprises storage control means 61, frame data generating means 64, and the DMD controller 65. The storage control means 61 receives the image data from the image data output apparatus 70, and stores the image data in image data storage means 62. The frame data generating means 64 reads image drawing point data from the image data stored in the image data storage means 62, and stores the image drawing spot data in frame data storage means 63. The frame data generating means 64 also generates the frame data sets based on the image drawing point data stored in the frame data storage means 63. The DMD controller 65 outputs the control signals to each of the DMDs 36 based on the frame data sets outputted from the frame data generating means 64. The storage control means 61 and the frame data generating means 64 stores computer programs for execution of predetermined procedures, and the overall control unit 60 controls operation of the exposure apparatus 10 according to the procedures. The procedures of the respective programs will be described later.

DRAMs may be used as the image data storage means 62 and the frame data storage means 63, for example. However, as long as the data stored therein can be read fast and sequentially in a direction of consecutive addresses, any means may be used. For example, storage means from which stored data are read by so-called burst transfer in the direction of consecutive addresses may be used as the image data storage means 62 and the frame data storage means 63. The direction of consecutive addresses refers to a direction along which addresses in a memory space are consecutive for control means such as the CPU that controls storage in the image data storage means and the frame data storage means and reading therefrom, or a direction of address assignment that enables fast access. The direction of consecutive addresses may be a direction along a path from which consecutive bits are read sequentially at the time of data reading. Large-size data such as image data are often stored in an inexpensive DRAM, which leads to a demerit of slow random access.

The operation of the exposure apparatus 10 will be described below in detail.

The image data output apparatus 70 such as a computer generates the image data according to an image to be formed on the photosensitive material 12, and the image data are outputted to the exposure apparatus 10. The image data are received by the storage control means 61 of the exposure apparatus 10.

In the case where a figure “2” is drawn on an exposure surface, for example, the storage control means 61 stores the image data in the image data storage means 62 as shown in FIG. 7 in such a manner that the direction of consecutive addresses in the image data storage means 62 agrees with a direction of reading of the image drawing spot data corresponding to image drawing spots formed along the scanning direction of the DMDs 36 (that is, a data arrangement direction corresponding to the scanning direction), for the entire image data or for at least a portion of the image data. FIG. 7 shows a relationship between the address space in the image data storage means 62 for the storage control means 61 and the image data stored in the image data storage means 62. In the case where the image data outputted from the image data output apparatus 70 are vector data, the storage control means 61 converts the vector data into bitmap data and stores the image drawing spot data as has been described above. In this case, the storage control means 61 can store the data as shown in FIG. 7, by rotating raster data having been converted from the vector data or by carrying out conversion to raster data on rotated vector data.

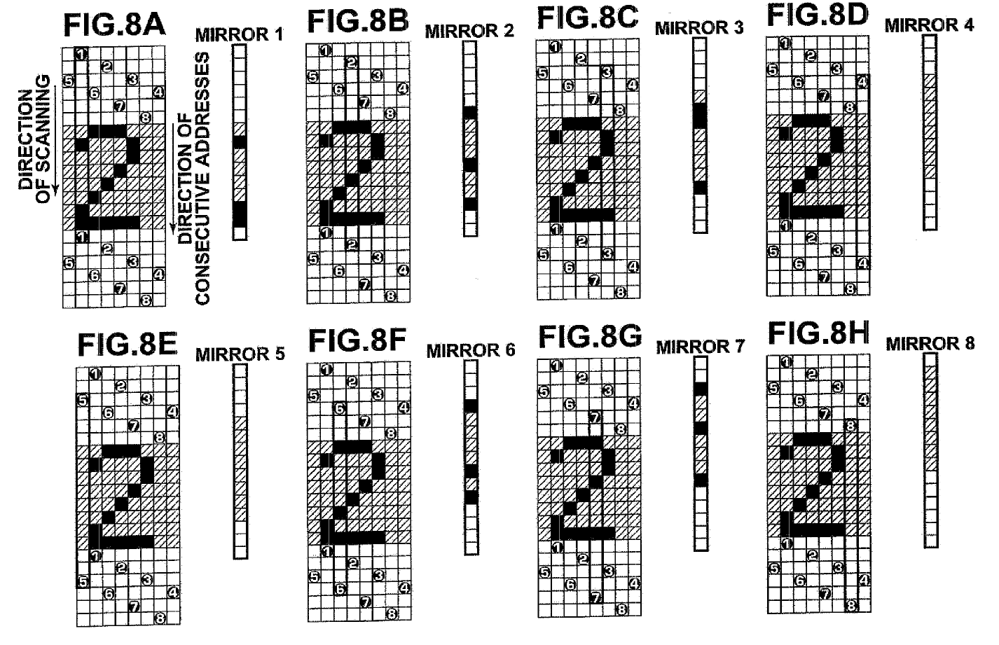

After all (or a portion) of the image data have (has) been stored in the image data storage means 62 in the above manner, the frame data generating means 64 reads the image data stored in the image data storage means 62. The frame data generating means 64 sequentially reads the image data stored in the image data storage means 62 in the direction of consecutive addresses as shown in FIGS. 8A to 8H, and obtains the image drawing spot data for the respective micro-mirrors. The image data are read for the respective micro-mirrors, in the order of addresses corresponding to the respective micro-mirrors (that is, the order of addresses of the data to be fed to the respective micro-mirrors). By reading the image data in this manner, the number of invalid bits can be decreased in byte access in the case where a pitch of movement of beam spots is smaller than a pitch between the beam spots in the exposure surface (an image drawing surface). Consequently, fast and/or efficient data reading can be realized.

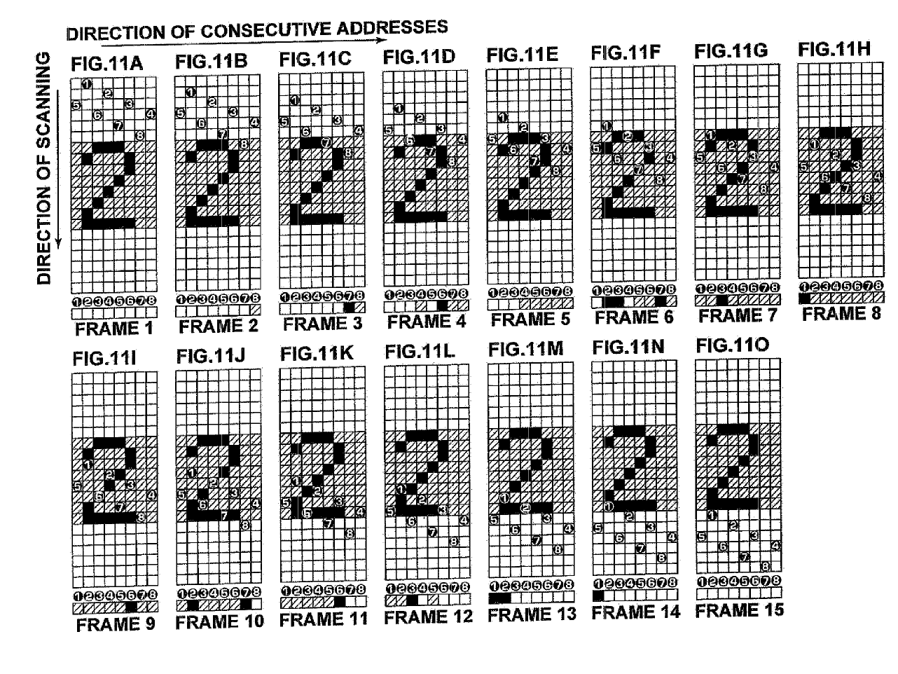

The symbols in FIGS. 8A to 8H are the same as in FIGS. 11A to 11O. As a method of reading the image data stored in the image data storage means 62, a method may be used wherein each of the image drawing spot data is read once. In addition, a method may be used wherein each of the image drawing spot data is read more than once while the image data are sampled at a predetermined pitch. Alternatively, the image drawing spot data may be read by being thinned. These manners of reading enable conversion of resolution of the image data. Furthermore, the image drawing spot data can be read from the image data generated at an arbitrary data pitch. In this case, consecutive bits including the image drawing spot data that are valid and invalid data are read collectively as interim data, and the desired valid image drawing spot data are extracted from the interim data.

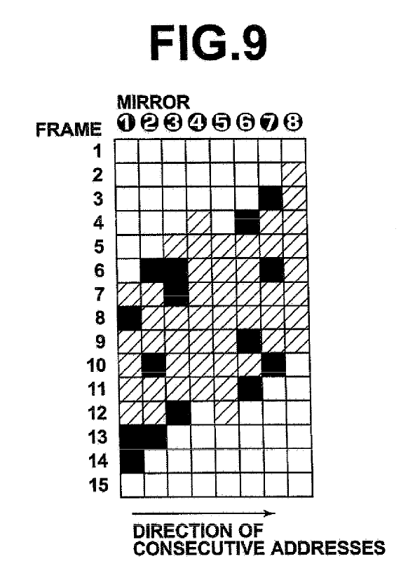

The frame data generating means 64 stores the image drawing spot data for the respective micro-mirrors obtained in the above manner in the frame data storage means 63. At this time, the frame data generating means 64 stores the image drawing spot data in the frame data storage means 63 in such a manner that a direction of consecutive addresses in the frame data storage means 63 agrees with a direction of arrangement of the image drawing spot data belonging to the respective frame data sets, as shown in FIG. 9. FIG. 9 shows a relationship between an address space in the frame data storage means 63 for the frame data generating means 64 and the frame data sets stored in the frame data storage means 63. By storing the image drawing spot data for the respective micro-mirrors in the frame data storage means 63 in the above manner, the frame data generating means 64 has actually carried out 90-degree rotation or matrix transposing processing on the image data in the image data storage means 62.

After the image drawing spot data for the respective micro-mirrors have been stored in the frame data storage means 63 in the above manner, the frame data generating means 64 sequentially reads the image drawing spot data stored in the frame data storage means 63 for respective frames in the direction of consecutive addresses, to generate frame data sets 1 to 15. The frame data generating means 64 sequentially outputs the frame data sets 1 to 15 to the DMD controller 65, and the DMD controller 65 generates the control signals according to the frame data sets having been inputted thereto. The frame data sets described above are generated for each of the DMDs 36 of the exposure heads 30. The image drawing spot data may be read for the respective micro-mirrors at predetermined timings and sequentially outputted to the DMD controller 65.

While the control signals are generated for each of the exposure heads 30, the overall control unit 60 outputs a stage driving control signal to the stage driving unit 80 for causing the stage driving unit 80 to move the stage 14 along the guide rails 20 in the direction of stage movement at a desired speed according to the stage driving control signal. Image drawing by the respective exposure heads 30 starts in response to output of the control signals from the DMD controller 65 to the DMDs 36 of the respective exposure heads 30 when the sensors 26 attached to the gate 22 detect the front end of the photosensitive material 12 while the stage 14 is passing under the gate 22.

The photosensitive material 12 moves at the predetermined speed together with the stage 14, and the photosensitive material 12 is scanned by the scanner 24 in the direction opposite to the direction of movement of the stage 14. The strips of the exposed areas 34 are formed by the respective exposure heads 30. The frame data sets may be generated sequentially in parallel to control of the movement of the stage 14.

After the scanner 24 has scanned the photosensitive material 12 in the above manner and the sensors 26 have detected the rear end of the photosensitive material 12, the stage driving unit 80 moves the stage 14 back to the starting position of the gate 22 along the guide rails 20, and a new photosensitive material 12 is set thereon. Thereafter, the stage 14 moves from the starting position of the gate 22 at the predetermined speed along the guide rails 20.

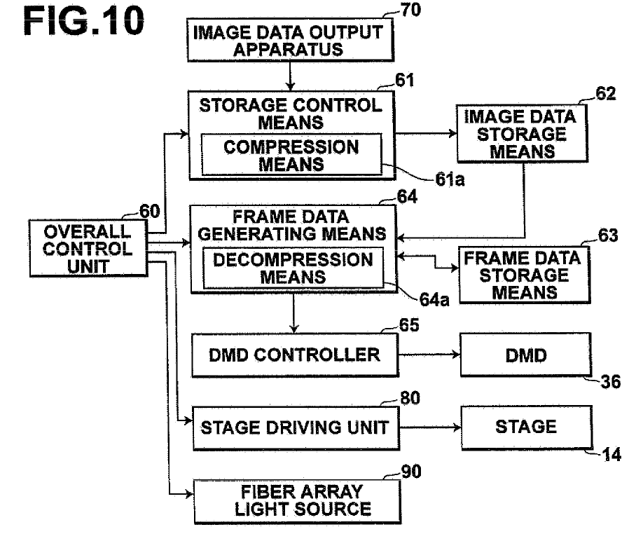

The exposure apparatus 10 may further comprise compression means 61a and decompression means 64a, as shown in FIG. 10. The compression means 61a carries out compression processing on the image data received by the storage control means 61, in the direction corresponding to the image drawing spots aligned in the direction of scanning (or generates raster image data converted in a compressed state from vector data). The compressed image data are stored in the image data storage means 62 in such a manner that the direction of consecutive addresses in the image data storage means 62 agrees with the order of storing the compressed data. Upon generation of the frame data sets, the frame data generating means 64 sequentially reads the compressed image data from the image data storage means 62 in the direction of consecutive addresses, and the decompression means 64a decompresses the compressed image data having been read. Thereafter, the image drawing spot data are read for the respective micro-mirrors and stored in the frame data storage means 63 in the same manner as has been described above. The procedures after storage of the image drawing spot data in the frame data storage means 63 are the same as has been described above. In the case where the pitch of the image data is the same as the pitch of reading of the image drawing spot data, the compressed image data having been read and decompressed thereafter become the image drawing spot data. By compressing the image data in the direction of scanning, a range of the data for each of the micro-mirrors can be easily identified at the time of reading of the data. For example, the image drawing spot data can be obtained by identifying the range of the data corresponding to one of the micro-mirrors for which the data are read and by decompressing only the data in the range, without decompression of all the compressed image data.

In the above description, the image data are compressed and stored in the image data storage means 62. However, the image data may be stored temporarily in the image data storage means 62 as they are. In this case, the image data stored in the image data storage means 62 in the direction of consecutive addresses are compressed, and the compressed image data are stored again in the image data storage means 62.

In the case where the image data are binary data, runlength compression may be used as the compression processing.

In the above embodiment, the image data storage means 62 and the frame data storage means 63 are separate. However, the same memory or the like may be shared as the image data storage means 62 and the frame data storage means 63.

In the embodiment described above, the exposure apparatus having the DMDs as the spatial light modulators has been described. However, transmissive spatial light modulators may be used instead of reflective spatial light modulators described above. In addition, a GLV (Grating Light Valve) may be used. A lamp may also be used as a light source.

As the image drawing spot forming unit of the present invention may be used not only the spatial light modulators but also orderly arranged light emitting elements or beam emitting elements. For example, an LD (Laser Diode) array, an LED (Light Emitting Diode) array, and a fiber array can be used.

In the above embodiment, the exposure apparatus of a flat-bed type has been described as an example. However, a so-called outer (or inner) drum exposure apparatus having a drum on which a photosensitive material is rolled may also be used.

The photosensitive material 12 to be exposed may be a printed substrate, a filter for display (such as a color filter or a black matrix) or a TFT panel. The shape of the photosensitive material 12 may be a sheet-like shape or an elongated shape (such as a shape of a flexible substrate).

The image drawing methods and the image drawing apparatuses of the present invention can also be applied to image drawing control by an ink-jet printer or the like. For example, image drawing spots generated by discharging ink can be controlled by the same method of the present invention. In other words, the elements of image drawing in this invention can be replaced with elements generating image drawing spots by discharging ink.

Likewise, the present invention can be applied to an image drawing apparatus of a dot-impact type.

As the memory to store the image data, a memory having fast speed of random access such as an SRAM (Static Random Access Memory) may be used. In this case, a direction of consecutive addresses in the memory is defined to agree with the direction of stored data (or data to be stored) corresponding to the scanning direction of the DMDs 36. In addition, the data are read in the direction of consecutive addresses. In this case, the memory may have been wired or programmed so as to cause data reading therefrom to be carried out in the direction of consecutive addresses.

What is claimed is:

1. An image data storage method for storing image data for obtaining image drawing spot data to be inputted to an image drawing spot forming unit that forms image drawing spots on an image drawing surface, the method comprising the step of:
storing the image data in storage means in such a manner that a direction along which addresses in the storage means are consecutive agrees with a direction of arrangement of the image data corresponding to a predetermined scanning direction of the image drawing spot forming unit relative to the image drawing surface.

2. The image data storage method according to claim 1, wherein the storage means is configured or set to enable collective reading of a plurality of bits along the direction of consecutive addresses at the time of reading of the image data.

3. The image data storage method according to claim 1, wherein the direction of consecutive addresses is a direction configured or set as a path in which a plurality of bits are sequentially read at the time of reading of the image data from the storage means.

4. An image data storage method for storing image data for obtaining image drawing spot data to be inputted to an image drawing spot forming unit that forms image drawing spots on an image drawing surface, the method comprising the steps of:
carrying out compression processing on the image data along a direction of arrangement of the image data corresponding to a scanning direction of the image drawing spot forming unit relative to the image drawing surface; and
storing compressed image data having been generated by the compression processing in storage means in such a manner that a direction along which the compressed image data are arranged agrees with a direction of consecutive addresses in the storage means.

5. The image data storage method according to claim 4 wherein the image data are binary data and the compression processing is runlength compression.

6. The image data storage method according to claim 1 wherein the image drawing spot forming unit comprises a plurality of orderly arranged modulators modulating an incident light.

7. The image data storage method according to claim 6 wherein the image drawing spot forming unit is a GLV (Grating Light Valve).

8. The image data storage method according to claim 6 wherein the image drawing spot forming unit is a digital micro-mirror device.

9. The image data storage method according to claim 1 wherein the image drawing spot forming unit is a plurality of light emitting elements arranged orderly.

10. A data acquisition method comprising the step of obtaining the image drawing spot data or interim data including more than one of the image drawing spot data by reading in the direction of consecutive addresses the image data stored in the storage means according to the image data storage method of claim 1.

11. The data acquisition method according to claim 10, wherein the image drawing spot data or the interim data are read for respective elements of the image drawing spot forming unit.

12. A data acquisition method comprising the steps of:
reading the compressed image data stored in the storage means according to the image data storage method of claim 4, in the direction of consecutive addresses; and
obtaining the image drawing spot data by decompressing the compressed image data having been read.

13. A frame data generation method for generating frame data sets by reading the image drawing spot data from the image data stored in the storage means according to the image data storage method of claim 1, the frame data generation method comprising the steps of:
reading the image drawing spot data from the image data stored in the storage means, in the direction of consecutive addresses; and
generating the frame data sets by obtaining more than one of the image drawing spot data belonging to each of the frame data sets from more than one of the image drawing spot data having been read.

14. The frame data generation method according to claim 13 using frame data storage means from which the image drawing spot data stored therein can be read sequentially in a direction of consecutive addresses, the frame data generation method further comprising the step of:
storing the image drawing spot data in the frame data storage means in such a manner that the direction of consecutive addresses agrees with a direction of arrangement of the image drawing spot data belonging to the respective frame data sets, wherein
the step of generating the frame data sets is the step of generating the frame data sets by sequentially reading the image drawing spot data belonging to the respective frame data sets.

15. A frame data generation method comprising the steps of:
sequentially reading the compressed image data stored in the storage means according to the image data storage method of claim 4, in the direction of consecutive addresses;
generating more than one of the image drawing spot data by carrying out decompression on the compressed image data having been read; and
thereafter generating frame data sets by obtaining more than one of the image drawing spot data belonging to each of the frame data sets from said more than one of the image drawing spot data having been generated.

16. The frame data generation method according to claim 15 using frame data storage means from which the image drawing spot data stored therein can be read sequentially in a direction of consecutive addresses, the frame data generation method further comprising the step of:
storing the image drawing spot data in the frame data storage means in such a manner that the direction of consecutive addresses agrees with a direction of arrangement of the image drawing spot data belonging to the respective frame data sets after the decompression, wherein
the step of generating the frame data sets is the step of generating the frame data sets by sequentially reading the image drawing spot data belonging to the respective frame data sets.

17. An image drawing method comprising the steps of:
obtaining the image drawing spot data according to the data acquisition method of claim 10; and
forming an image on the image drawing surface by moving the image drawing spot forming unit relatively to the image drawing surface in the predetermined scanning direction while generating the image drawing spots through sequential input of the image drawing spot data to the image drawing spot forming unit according to movement of the image drawing spot forming unit in the scanning direction.

18. An image drawing method comprising the steps of:
obtaining the image drawing spot data according to the data acquisition method of claim 12; and
forming an image on the image drawing surface by moving the image drawing spot forming unit relatively to the image drawing surface in the predetermined scanning direction while generating the image drawing spots through sequential input of the image drawing spot data to the image drawing spot forming unit according to movement of the image drawing spot forming unit in the scanning direction.

19. An image drawing method comprising the steps of:
obtaining the frame data sets according to the frame data generation method of claim 13; and
forming an image on the image drawing surface by moving the image drawing spot forming unit relatively to the image drawing surface in the predetermined scanning direction while temporally serially generating the image drawing spots through sequential input of the frame data sets to the image drawing spot forming unit according to movement of the image drawing spot forming unit in the scanning direction.

20. An image drawing method comprising the steps of:
obtaining the frame data sets according to the frame data generation method of claim 15; and
forming an image on the image drawing surface by moving the image drawing spot forming unit relatively to the image drawing surface in the predetermined scanning direction while temporally serially generating the image drawing spots through sequential input of the frame data sets to the image drawing spot forming unit according to movement of the image drawing spot forming unit in the scanning direction.

21. An image data storage control apparatus for storing in storage means image data for obtaining image drawing spot data to be inputted to an image drawing spot forming unit that forms image drawing spots on an image drawing surface, the apparatus comprising:
storage control means for storing the image data in the storage means in such a manner that a direction along which addresses in the storage means are consecutive agrees with a direction of arrangement of the image data corresponding to a predetermined scanning direction of the image drawing spot forming unit relative to the image drawing surface.

22. The image data storage control apparatus according to claim 21, wherein the storage means is configured or set to enable collective reading of a plurality of bits along the direction of consecutive addresses at the time of reading of the image data.

23. The image data storage control apparatus according to claim 21, wherein the direction of consecutive addresses is a direction configured or set as a path in which a plurality of bits are sequentially read at the time of reading of the image data from the storage means.

24. An image data storage control apparatus for storing in storage means image data for obtaining image drawing spot data to be inputted to an image drawing spot forming unit that forms image drawing spots on an image drawing surface, the apparatus comprising:
compression processing means for carrying out compression processing on the image data along a direction of arrangement of the image data corresponding to a scanning direction of the image drawing spot forming unit relative to the image drawing surface; and
storage control means for storing compressed image data having been generated through the compression processing by the compression processing means in the storage means in such a manner that a direction along which the compressed image data are arranged agrees with a direction of consecutive addresses in the storage means.

25. The image data storage control apparatus according to claim 24 wherein the image data are binary data and the compression processing is runlength compression.

26. The image data storage control apparatus according to claim 21 wherein the image drawing spot forming unit comprises a plurality of orderly arranged modulators modulating an incident light.

27. The image data storage control apparatus according to claim 26 wherein the image drawing spot forming unit is a GLV (Grating Light Valve).

28. The image data storage control apparatus according to claim 26 wherein the image drawing spot forming unit is a digital micro-mirror device.

29. The image data storage control apparatus according to claim 21 wherein the image drawing spot forming unit is a plurality of light emitting elements arranged orderly.

30. A data acquisition apparatus comprising:
the image data storage control apparatus of claim 21; and
a data acquisition unit for obtaining the image drawing spot data or interim data including more than one of the image drawing spot data by reading in the direction of consecutive addresses the image data stored in the storage means by the image data storage control apparatus.

31. The data acquisition apparatus according to claim 30, wherein the data acquisition unit reads the image drawing spot data or the interim data for respective elements of the image drawing spot forming unit.

32. A data acquisition apparatus comprising:
the image data storage control apparatus of claim 24; and
a data acquisition unit for reading in the direction of consecutive addresses the compressed image data stored in the storage means by the image data storage control apparatus and for obtaining the image drawing spot data by decompressing the compressed image data.

33. A frame data generation apparatus comprising:
the first image data storage control apparatus of claim 21; and
frame data generating means for generating frame data sets by reading the image drawing spot data from the image data stored in the storage means by the image data storage control apparatus, wherein
the frame data generating means reads the image drawing spot data from the image data stored in the storage means, in the direction of consecutive addresses, and
generates the frame data sets by obtaining more than one of the image drawing spot data belonging to each of the frame data sets from more than one of the image drawing spot data having been read.

34. The frame data generation apparatus according to claim 33 further comprising:
frame data storage means from which the image drawing spot data stored therein can be read sequentially in a direction of consecutive addresses, wherein
the frame data generating means stores the image drawing spot data in the frame data storage means in such a manner that the direction of consecutive addresses agrees with a direction of arrangement of the image drawing spot data belonging to the respective frame data sets, and thereafter generates the frame data sets by sequentially reading the image drawing spot data belonging to the respective frame data sets.

35. A frame data generation apparatus comprising:
the image data storage control apparatus of claim 24; and
frame data generating means for sequentially reading in the direction of consecutive addresses the compressed image data stored in the storage means by the image data storage control apparatus, for generating more than one of the image drawing spot data by carrying out decompression on the compressed image data having been read, and for generating frame data sets by obtaining more than one of the image drawing spot data belonging to each of the frame data sets from said more than one of the image drawing spot data having been generated.

36. The frame data generation apparatus of claim 35 further comprising:
frame data storage means from which the image drawing spot data stored therein can be read sequentially in a direction of consecutive addresses, wherein
the frame data generating means stores the image drawing spot data in the frame data storage means in such a manner that the direction of consecutive addresses agrees with a direction of arrangement of the image drawing spot data belonging to the respective frame data sets after the decompression, and thereafter generates the frame data sets by sequentially reading the image drawing spot data belonging to the respective frame data sets.

37. An image drawing apparatus comprising:
the data acquisition apparatus according to claim 30;
the image drawing spot forming unit that forms the image drawing spots on the image drawing surface based on the image drawing spot data inputted thereto;
moving means for moving the image drawing spot forming unit in the predetermined scanning direction relatively to the image drawing surface; and
image forming control means for sequentially inputting to the image drawing spot forming unit the image drawing spot data obtained by the data acquisition apparatus according to the movement in the scanning direction by the moving means and for forming an image on the image drawing surface by causing the image drawing spot forming unit to sequentially form the image drawing spots.

38. An image drawing apparatus comprising:
the data acquisition apparatus according to claim 32;
the image drawing spot forming unit that forms the image drawing spots on the image drawing surface based on the image drawing spot data inputted thereto;
moving means for moving the image drawing spot forming unit in the predetermined scanning direction relatively to the image drawing surface; and
image forming control means for sequentially inputting to the image drawing spot forming unit the image drawing spot data obtained by the data acquisition apparatus according to the movement in the scanning direction by the moving means and for forming an image on the image drawing surface by causing the image drawing spot forming unit to sequentially form the image drawing spots.

39. An image drawing apparatus comprising:
the frame data generation apparatus according to claim 33;
the image drawing spot forming unit that forms the image drawing spots on the image drawing surface based on the frame data sets inputted thereto;
moving means for moving the image drawing spot forming unit in the predetermined scanning direction relatively to the image drawing surface; and
image forming control means for sequentially inputting to the image drawing spot forming unit the frame data sets generated by the frame data generation apparatus according to the movement in the scanning direction by the moving means and for forming an image on the image drawing surface by causing the image drawing spot forming unit to temporally serially form the image drawing spots.

40. An image drawing apparatus comprising:
the frame data generation apparatus according to claim 35;
the image drawing spot forming unit that forms the image drawing spots on the image drawing surface based on the frame data sets inputted thereto;
moving means for moving the image drawing spot forming unit in the predetermined scanning direction relatively to the image drawing surface; and
image forming control means for sequentially inputting to the image drawing spot forming unit the frame data sets generated by the frame data generation apparatus according to the movement in the scanning direction by the moving means and for forming an image on the image drawing surface by causing the image drawing spot forming unit to temporally serially form the image drawing spots.

41. A recording medium storing an image data storage program causing a computer to execute the procedure of storing in storage means image data for obtaining image drawing spot data to be inputted to an image drawing spot forming unit that forms image drawing spots on an image drawing surface, the program comprising the procedure of:
storing the image data in the storage means in such a manner that a direction along which addresses in the storage means are consecutive agrees with a direction of arrangement of the image data corresponding to a predetermined scanning direction of the image drawing spot forming unit relative to the image drawing surface.

42. A recording medium storing an image data storage program causing a computer to execute the procedures for storing in storage means image data for obtaining image drawing spot data to be inputted to an image drawing spot forming unit that forms image drawing spots on an image drawing surface, the program comprising the procedures of:
carrying out compression processing on the image data along a direction of arrangement of the image data corresponding to a scanning direction of the image drawing spot forming unit relative to the image drawing surface; and
storing compressed image data having been generated by the compression processing in the storage means in such a manner that a direction along which the compressed image data are arranged agrees with a direction of consecutive addresses in the storage means.

43. The recording medium storing the image data storage program according to claim 42 wherein the image data are binary data and the compression processing is runlength compression.

44. A recording medium storing a frame data generation program causing a computer to execute the procedures for generating frame data sets by reading the image drawing spot data from the storage means according to the image data storage program of claim 41, the frame data generation program comprising the procedures of:
reading the image drawing spot data from the image data stored in the storage means, in the direction of consecutive addresses; and
generating the frame data sets by obtaining more than one of the image drawing spot data belonging to each of the frame data sets from more than one of the image drawing spot data having been read.

45. A recording medium storing the frame data generation program of claim 44 further causing the computer to execute the procedure of:
storing the image drawing spot data in frame data storage means from which the image drawing spot data stored therein can be read sequentially in a direction of consecutive addresses, in such a manner that the direction of consecutive addresses agrees with a direction of arrangement of the image drawing spot data belonging to the respective frame data sets, wherein
the step of generating is the step of generating the frame data sets by sequentially reading the image drawing spot data belonging to the respective frame data sets.

46. An image data storage method comprising the steps of:
preparing image data for obtaining image drawing spot data to be inputted to respective image drawing elements at the time an image is formed through generation of serial image drawing spots in a relative scanning direction on an image drawing surface by the image drawing elements; and
storing the image data in storage means in such a manner that a direction along which addresses in the storage means are consecutive agrees with a direction of arrangement of the image data corresponding to the direction of serial generation of the image drawing spots.

47. An image data storage method comprising the steps of:
preparing image data for obtaining image drawing spot data to be inputted to respective image drawing elements at the time an image is formed through generation of serial image drawing spots in a relative scanning direction on an image drawing surface by the image drawing elements;
compressing the image data in a direction of data arrangement corresponding to the direction of serial generation of the image drawing spots; and
storing the compressed image data in storage means.

48. The image data storage method according to claim 47 wherein the step of storing is the step of storing the compressed image data in the storage means in such a manner that a direction along which addresses in the storage means are consecutive agrees with a direction of compression.

49. An image drawing method comprising the steps of:
reading image drawing spot data for respective image drawing elements from image data stored in storage means; and
forming an image through generation of serial image drawing spots in a scanning direction on an image drawing surface by the respective image drawing elements, based on the image drawing spot data having been read.

50. An image drawing method comprising the steps of:
reading image drawing spot data in order of addresses corresponding to respective image drawing elements from image data stored in storage means; and
forming an image through generation of serial image drawing spots in a scanning direction on an image drawing surface by the image drawing elements, based on the image drawing spot data having been read.

51. The image drawing method according to claim 49, wherein the step of reading is the step of collectively reading a plurality of bits at the time of reading of the image drawing spot data.

52. The image drawing method according to claim 50, wherein the step of reading is the step of collectively reading a plurality of bits at the time of reading of the image drawing spot data.

53. The image drawing method according to claim 49 further comprising the step of storing the image data in advance in the storage means in such a manner that a direction along which addresses in the storage means are consecutive agrees with a direction of arrangement of the image data corresponding to the direction of serial generation of the image drawing spots.

54. The image drawing method according to claim 50 further comprising the step of storing the image data in advance in the storage means in such a manner that a direction along which addresses in the storage means are consecutive agrees with a direction of arrangement of the image data corresponding to the direction of serial generation of the image drawing spots.

55. An image data storage control apparatus comprising:
image data acquisition means for obtaining image data for acquisition of image drawing spot data to be inputted to respective image drawing elements at the time an image is formed through generation of serial image drawing spots in a relative scanning direction on an image drawing surface by the image drawing elements; and
storage control means for storing the image data in storage means in such a manner that a direction along which addresses in the storage means are consecutive agrees with a direction of arrangement of the image data corresponding to the direction of serial generation of the image drawing spots.

56. An image data storage control apparatus comprising:
image data acquisition means for obtaining image data to be inputted to respective image drawing elements at the time an image is formed through generation of serial image drawing spots in a relative scanning direction on an image drawing surface by the image drawing elements;
compression processing means for compressing the image data in a direction of data arrangement corresponding to the direction of serial generation of the image drawing spots; and
storage control means for storing the compressed image data in storage means.

57. The image data storage control apparatus according to claim 56, wherein the storage control means stores the compressed image data in the storage means in such a manner that a direction along which addresses in the storage means are consecutive agrees with a direction of compression.

58. An image drawing apparatus comprising:
image drawing spot data acquisition means for obtaining image drawing spot data for respective image drawing elements by reading the image drawing spot data from image data stored in storage means; and
image drawing means for forming an image through generation of serial image drawing spots in a scanning direction on an image drawing surface by the respective image drawing elements, based on the image drawing spot data having been obtained by the image drawing spot data acquisition means.

59. An image drawing apparatus comprising:
image drawing spot data acquisition means for obtaining image drawing spot data by reading the image drawing spot data in order of addresses corresponding to image drawing elements from image data stored in storage means; and
image drawing means for forming an image through generation of serial image drawing spots in a scanning direction on an image drawing surface by the image drawing elements, based on the image drawing spot data having been obtained by the image drawing spot data acquisition means.

60. The image drawing apparatus according to claim 58, wherein the image drawing spot data acquisition means reads a plurality of bits collectively at the time of reading of the image drawing spot data.

61. The image drawing apparatus according to claim 59, wherein the image drawing spot data acquisition means reads a plurality of bits collectively at the time of reading of the image drawing spot data.

62. The image drawing apparatus according to claim 58 further comprising storage control means for storing the image data in advance in the storage means in such a manner that a direction along which addresses in the storage means are consecutive agrees with a direction of arrangement of the image data corresponding to the direction of serial generation of the image drawing spots.

63. The image drawing apparatus according to claim 59 further comprising storage control means for storing the image data in advance in the storage means in such a manner that a direction along which addresses in the storage means are consecutive agrees with a direction of arrangement of the image data corresponding to the direction of serial generation of the image drawing spots.
